(19) United States
(12) Patent Application Publication
(10) Pub. No.: US 2015/0082549 A1
(43) Pub. Date: Mar. 26, 2015

(54) BEDDING SYSTEMS

(71) Applicants: Simon CAIRNS, (US); Michael MORTIMER, (US)

(72) Inventors: Simon Cairns, Perth (AU); Michael Mortimer, Perth (AU)

(21) Appl. No.: 14/398,534

(22) PCT Filed: May 2, 2013
(86) PCT No.: PCT/AU2013/000457

§ 371 Date: Nov. 3, 2014

(30) Foreign Application Priority Data
May 3, 2012 (AU) 2012202600

(51) Int. Cl. A47C 27/14; B32B 38/04; B32B 37/18; B32B 37/12; A47C 27/15; A47C 21/04

(52) U.S. Cl. CPC A47C 27/148; A47C 27/15; A47C 21/046; B32B 37/18; B32B 37/12; B32B 38/04; B32B 2038/042; B32B 2305/022
USPC 5/724; 5/690; 5/727; 156/250

(57) ABSTRACT

In one preferred form there is provided a mattress (10) for a bed. The mattress (10) includes an upper layer (12) formed from visco elastic foam material of a first kind; an intermediate layer (14) formed from visco elastic foam material of a second kind; and a lower layer (16) formed from foam material of another kind. The intermediate layer (16) is provided between the upper layer (12) and the lower layer (16). The upper layer (12) and the intermediate layer (14) have a combined thickness of at least 50 mm. The lower layer (16) has a thickness of at least 70 mm.

### FIELD OF THE INVENTION

The present invention relates to bedding systems and in particular to mattresses.

### BACKGROUND TO THE INVENTION

A number of mattresses presently exist on the market. The applicants wish to provide an improved mattress for sleeping and possibly therapeutic purposes.

It is against this background and the problems and difficulties associated therewith that the present invention has been developed.

### SUMMARY OF THE INVENTION

According to a first aspect of preferred embodiments herein described there is provided a mattress for a bed, the mattress comprising: an upper layer formed from visco elastic foam material of a first kind; an intermediate layer formed from visco elastic foam material of a second kind; a lower layer formed from foam material of another kind; wherein the intermediate layer is provided between the upper layer and the lower layer; the upper layer and the intermediate layer have a combined thickness of at least 50 mm; and the lower layer has a thickness of at least 70 mm.

The upper layer, intermediate layer and the lower layer may each consist of a single unitary layer.

Preferably the upper layer and intermediate layer each consist of single unitary layer and the lower layer consists of two layers, namely an upper-lower layer and a lower-lower layer.

Preferably the layers are glued together with the upper layer being at least 25 mm in thickness, the intermediate layer being at least 30 mm in thickness and the lower layer being at least 100 mm in thickness.

Preferably the upper layer is formed from visco elastic foam of a hardness between 30 and 60 N; the intermediate layer is formed from visco elastic foam of a hardness between 70 and 110 N; and the lower layer is formed from foam of a hardness between 85 and 130 N.

Preferably the mattress includes a plurality of boundary members extending along the lateral sides of the mattress to provide the mattress with relatively firm side support portions.

Preferably the mattress includes a plurality of boundary members extending along the ends of the mattress to provide the mattress with relatively firm end support portions.

Preferably the upper layer is of a larger planar size than the intermediate layer and the lower layer, the boundary members surrounding the periphery of the intermediate layer and the lower layer, with the upper layer being disposed above the intermediate layer, the lower layer and the boundary members.

Preferably the density of the upper layer of visco elastic foam material is between 47 and 57 kg/m3; the density of the intermediate layer of visco elastic foam material is between 55 and 65 kg/m3; and the density of the lower layer of foam material is between 31 and 41 kg/m3.

Preferably the hardness of the upper layer of visco elastic foam material is between 30 and 60 (IFD 40%); the hardness of the intermediate layer of visco elastic foam material is between 75 and 105 (IFD 40%); and the hardness of the lower layer of foam material is between 115 and 155 (IFD 40%).

According to a second aspect of preferred embodiments herein described there is provided a mattress for a bed, the mattress comprising: at least one layer of visco elastic foam material; wherein a number of vertically extending ventilation passages extend through the at least one layer of visco elastic material so as to provide the mattress with a number of supportive zones.

Preferably the ventilation passages provide the mattress with seven supportive zones

Preferably at least some of the zones are of a depth of least 250 mm in the longitudinal direction along the mattress.

Preferably at least some of the zones are of a depth of least 300 mm in the longitudinal direction along the mattress.

Preferably the ventilation passages provide the sleeping zones with relatively soft and relatively firm sleeping zones that alternate along the length of the mattress.

Preferably the relatively firm sleeping zones each include only two or three internal rows of vertically extending passages.

Preferably the relatively soft sleeping zones each include less than 10 internal rows of vertically extending passages.

Preferably the relatively soft sleeping zones each include less than 6 internal rows of vertically extending passages.

According to a third aspect of preferred embodiments herein described there is provided a mattress for a bed, the mattress comprising: an upper layer formed from visco elastic foam material of a first kind; an intermediate layer of foam formed from visco elastic foam material of a second kind; and a lower layer formed from foam material of a third kind; wherein the mattress includes a number of vertically extending ventilation passages extending through the mattress from the upper surface of the upper layer through the lower surface of the lower layer.

According to a fourth aspect of preferred embodiments herein described there is provided a mattress for a bed comprising at least one layer of foam material wherein a number of vertically extending ventilation passages extend through the at least one layer of foam material so as to provide the mattress with a number of supportive zones.

According to a fifth aspect of preferred embodiments herein described there is provided a method of manufacturing a mattress, including: proactively forming a number of vertically extending ventilation passages in at least a one layer of visco elastic foam material, despite the visco elastic foam material having an open core structure allowing natural ventilation; and using the at least one layer of visco elastic foam material in the construction of the mattress.

Preferably proactively forming a number of vertically extending ventilation passages in the at least one layer of visco elastic foam material comprises forming the vertically extending passages in a first layer of visco elastic foam material of a first hardness and second layer of visco elastic foam material of a second hardness.

Preferably using the at least one layer of visco elastic foam material comprises fixing the second layer to a third layer of foam material in a manner in which the second layer provides an intermediate layer between the first layer of visco elastic foam material and the third layer of foam material.

Preferably applying the at least one layers of visco elastic foam material comprises fixing the first layer of visco elastic foam material to the second layer of visco elastic foam material.

Preferably the first layers of visco elastic foam material is larger than the second and third layers such that boundary members can be positioned around the periphery of the second and third foam layers to support the periphery of the first layer of foam material from below.

According to a sixth aspect of preferred embodiments herein described there is provided a method of manufacturing a mattress comprising: providing number of layers of visco elastic foam material; and forming a mattress using the layers of visco elastic foam material wherein a number of ventilation passages are provided that extend all the way through the mattress.

Preferably the method includes providing a first layer formed from visco elastic foam material of a first kind, gluing thereto a second and third layer of visco elastic material of a second and third kind to form a layered structure.

Preferably gluing thereto includes gluing a first pair of end supportive portions to the first, second and third layers at a respective upper end and a respective lower end of the layers.

Preferably the outward surface of third layer in the layered structure is then glued to a fourth layer of visco elastic material and a second pair of end supportive portions are glued to the first pair of end support portions to provide end supports extending from beneath the first layer.

Preferably the method includes gluing lateral side support portions that extend from beneath the first layer.

Preferably the ventilation passages extend through the first, second, third and fourth layers and the support portions do not include any ventilation passages.

Hardness measurements are to be understood as referring to compressing a standard sized piece of foam to 40% with the force required to achieve that compression being measured in Newtons. Hardness tests are those applied to standard Dunlop foams. For example Dunlop Enduro™ EN36-130 foam has a hardness range of 120-150. Density refers to the weight of the foam in kilograms per cubic meter. For example Dunlop Enduro™ EN36-130 foam has a density of about 36 kg/m3. Resilience and indentation factors are also standard measures. For example Dunlop Enduro™ EN36-130 has an indentation factor of about 2.39 and a resilience of about 55%. Dunlop foam technical manuals and standards are readily available.

### BRIEF DESCRIPTION OF DRAWINGS

In order to facilitate a better understanding of the present invention, several preferred embodiments will now be described with reference to the accompanying drawings, in which:

FIG. 1 provides a perspective view of a mattress according to a first preferred embodiment of the present invention;

FIG. 2 provides a plan view of the mattress shown in FIG. 1;

FIG. 3 provides an exploded perspective view of the mattress shown in FIG. 1;

FIG. 4 provides a detailed plan view of the mattress shown in FIG. 1;

FIGS. 5a and 5b illustrate a method according to a second preferred embodiment of the present invention;

FIGS. 6 and 7 provide spacing views illustrating rows of apertures in mattresses according to further preferred embodiments of the present invention;

FIGS. 8 to 10 illustrate further preferred embodiments; and

FIGS. 11 to 20 provide several views illustrating yet further preferred embodiments of the present invention.

### DETAILED DESCRIPTION OF THE EMBODIMENTS

It is to be appreciated that each of the embodiments is specifically described and that the present invention is not to be construed as being limited to any specific feature or element of any one of the embodiments. Neither is the present invention to be construed as being limited to any feature of a number of the embodiments or variations described in relation to the embodiments.

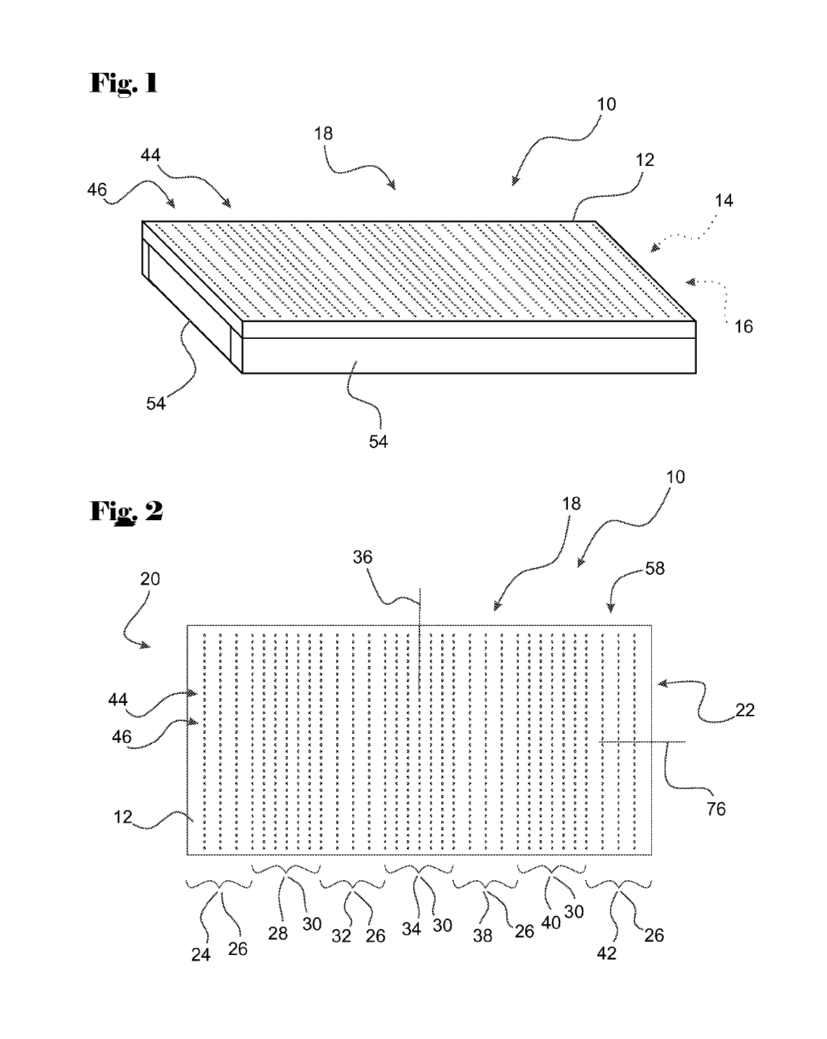

Referring to FIGS. 1 to 3 there is shown a mattress 10 according to a first preferred embodiment of the present invention. The mattress 10 includes an upper layer 12, an intermediate layer 14 and a lower layer 16. The mattress 10 is considered to be of advantageous form as well to provide a number of advantageous supportive zones 18. This is described in further detail below.

The upper layer 12 is formed from visco elastic foam material of a first density & hardness and provides a unitary visco elastic foam top layer. The intermediate layer 14 is formed from visco elastic foam material of a second density & hardness and provides a unitary visco elastic foam middle layer. The lower layer 16 comprises a supportive standard foam layer formed from foam material of a third density & hardness. In the embodiment the layers are glued together with a non-toxic water based adhesive to form the advantageous mattress 10.

More particularly, the upper layer 12 comprises visco elastic foam material for providing relative slow recovery support to the neck, shoulders, knees and back of the user. The intermediate layer 14 comprises visco elastic foam for providing relatively slow recovery support.

The upper layer 12 has a hardness of about 40N. The intermediate layer 14, on the other hand, has a hardness of about 90N. This provides a factor about 2 times the hardness of the upper layer 12. Of course various embodiments are possible including embodiment where the factor is greater than 2 times.

The lower layer 16 comprises a resilient standard foam designed to support the upper layer 12 and the intermediate layer 14. The lower layer 16 assists in distributing pressure while providing a suitable mattress core. The lower layer 16 has a hardness of about 130 N.

Advantageously the mattress 10 provides a triple layer comprising three (3) distinct layers and grades of foam.

The applicant considers that in the industry a single layer of visco elastic foam is typically used to provide a mattress. It may be also that occasionally, the visco elastic foam is provided together with a standard foam base. The present embodiment is considered to provide a substantial improvement to existing visco elastic foam beds in terms of the support provided to the head, neck, shoulders, hips, body and limbs of the user.

In the present embodiment the lower layer 16 comprises a premium grade standard foam base. As described there is provided a relatively firm premium visco elastic foam intermediate layer 14 above the lower layer 16. A softer further premium visco elastic foam upper layer 12 is provided above the intermediate layer 14.

In the advantageous combination, the lower layer 16 provides a good firm supportive base for the intermediate layer 14 and the upper layer 12. The lower layer 16 affords sufficient “give” to allow a relatively high degree of comfort.

In the embodiment, the lower layer 16 is not a visco elastic “memory foam” layer but comprises a premium grade open cell foam. The open cell foam does not include any CFCs or any other toxins.

By virtue of the intermediate layer 14 being formed from relatively firm premium visco elastic foam (“memory foam”) this is considered to advantageously even out and distribute pressure from the heavier/bulkier parts of the body, such as the shoulders and hips, and advantageously promotes improved spinal posture.

The upper layer 12 provides an added comfort layer advantageously configured to provide a softer supportive layer catering, in particular, for the user's limbs and face.

In the present embodiment it has been found that Dunlop Viscoflex™ VF52-40 and VF60-90 provide a particularly advantageous combination for the upper layer 12 and the intermediate layer 14. A Dunlop Enduro™ EN36-130 foam has been found to be advantageous for the lower layer 16. Associated characteristics of the layers of foam tabulated below.

| | Density | Hardness | Indentation | Resilience |
|---|---|---|---|---|
| Grade | (kg/m3) | (IFD 40%) | Factor | MIN % |
| VF52-40 | 52 | 35-55 | 2.67 | 5 |
| VF60-90 | 60 | 80-100 | 2.19 | 15 |
| EN36-100 | 36 | 95-120 | 2.44 | 55 |
| EN36-130 | 36 | 120-150 | 2.39 | 55 |

*Source Dunlop Catalogue June 2007

In the embodiment the upper layer 12 has a thickness of about 35 mm, the intermediate layer 14 has a thickness of about 50 mm and the lower layer has a thickness of about 130 mm. Such thicknesses have been seen to advantageously provide sleeping comfort and, in the applicant's opinion, a degree of therapeutic comfort as well. Different thicknesses of the layers are of course possible.

In preferred embodiments upper layer and intermediate layer combined thicknesses are preferably at least 60 mm and the lower layer thickness is at least 80 mm. Other ranges are of course possible. In addition, the provision of the layered sandwich structure is considered to be particularly advantageous in combination with the seven distinct supportive zones 18.

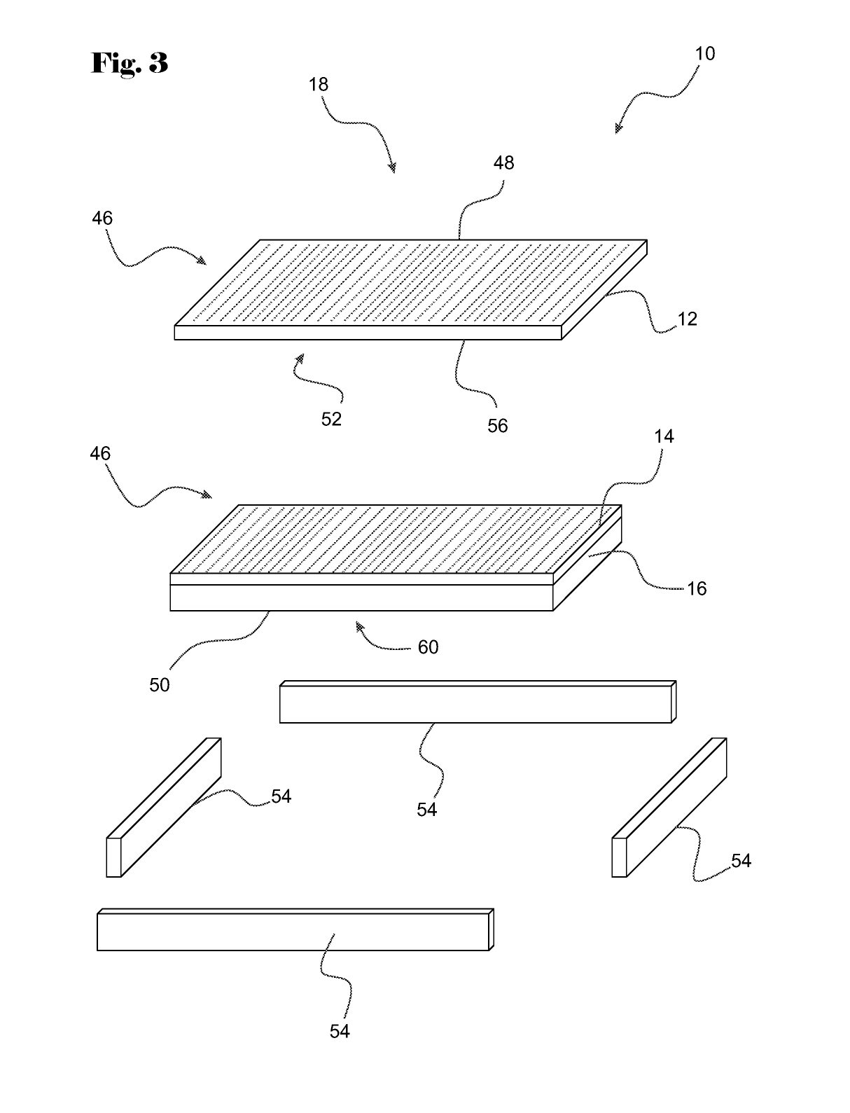

As shown in FIG. 2 the zones 18 start from a first end 20 of the mattress 10 and are spaced therealong. The zones 18 terminate at an opposite end 22. A first zone 24 is provided at the first end 20 of the mattress 10 and comprises a relatively firm zone 26. A second zone 28 is provided adjacent the first zone 24 and comprises a relatively soft zone 30. A third zone 32 adjacent the second zone 28 comprises another relatively firm zone 26.

A fourth zone 34 adjacent the third zone 32 provides a central relatively soft zone. The zones described alternate along the full length of the mattress 10. The fourth zone 34 provides a mirror axis 36. As a result a fifth zone 38, a sixth zone 40 and a seventh zone 42 are also provided.

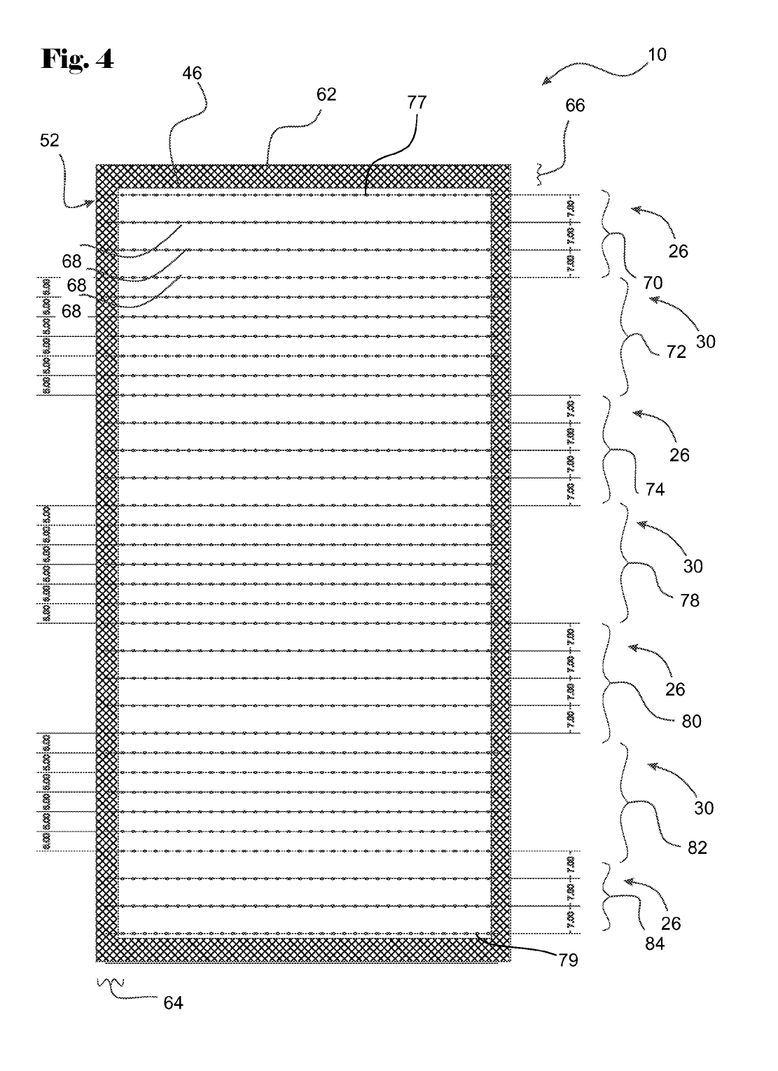

In order to provide the zones 18, a plurality of relatively small apertures 44 are provided. The apertures 44 extend through the upper layer 12, the intermediate layer 14 and the lower layer 16 to provide a plurality of ventilation passages 46. As shown in FIG. 3, the ventilation passages 46 extend all the way through the mattress 10 from the upper surface 48 of the upper layer 12 to the lower surface 50, of the lower layer 16.

The ventilation passages 46 are advantageously spaced in rows 52. As shown the rows 52 are spaced apart along the length of the mattress 10. The ventilation passages 46 in each row extend across the mattress 10.

The ventilation passages 46 are advantageously sized to be about 5 mm in diameter which serves to retain a consistency of the foam support as well as provide advantageous breathability. The ventilation passages 46 are spaced about 15 mm apart in reach row.

The supportive zones 18 are provided using a longitudinal spacing of about 70 mm between adjacent rows in the relatively firm zones 30 and a spacing of about 50 mm in the relative soft zones 26. The size of each relatively soft zone 30 is advantageously about 1.5 times the size of each relatively firm zone 26. This has been seen to advantageously provide comfort to the end user in the 3 layer mattress 10 as described.

As a combination, the mattress 10 is considered to form an advantageous “sandwich” of various open cell foams. The open cell foams advantageously provide breathability due to their open cell structure already known as being ‘fully ventilated’. The applicant has further provided additional ventilation passages 46 as described. The applicant further considers that, to the best of the applicant's knowledge, this goes against conventional judgement and provides a significant improvement to existing visco elastic mattresses. The applicant considers that, to the best of the applicant's knowledge, such mattresses have never been ventilated in such a manner in the past and that this provides significant advantages.

More particularly the ventilation passages 46 are provided by punching out (in a predetermined ratio) the series of 5 mm diameter cores. The addition of the apertures 44 provides the advantageous zoning structure in addition to the open cell structure of the foam. To the best of the applicant's knowledge, the applicant is not aware of any mattresses having punched out cores to provide several comfort zones along the length of the mattress.

In the embodiment the spacing of the ventilation passages 46 is carefully selected to ensure than pressures above 45 mmHg are not provided even in the case of a 100 kg male in a normal sleeping position that is: (i) when lying on his back; or (ii) when lying on his side.

In such a case the seven zoned 3 layered visco elastic structure is considered to advantageously serve to reduce pressure on the hips and shoulders and provide a comfortable and therapeutic sleeping position. Pressures less than 45 mmHg are advantageously provided for this purpose. In comparison to standard foam mattresses, the mattress 10 is considered to reduce pressure relatively significantly on all body parts.

As discussed, the ventilation passages 46 in the zoned structure are considered to provide advantageous ventilation to assist with ensuring comfortable sleeping. This ventilation provides a notably comfortable sleeping experience in terms of current known issues. With the present embodiment the ventilation passages 46 serve to limit adverse heat build up as well as to provide the advantageous supportive zones 18. By varying the distance between rows of the ventilation passages 46 softer zones advantageously accommodate the heavier/bulkier parts of the body. This further enhances the various functions of the triple layer foam sandwich. With standard bedding mattresses of foam material may act as a heat trap and may far exceed comfortable sleeping temperatures.

Each of the foams described is, in this case, an Australian made breathable visco elastic foam that does not contain formaldehyde or CFCs. Furthermore, the mattress 10 does not contain any metal or metal fittings. The applicant considers that this may be advantageous because there is some evidence that metal beds and spring mattresses amplify electro-magnetic radiation and may cause restless sleep, and some health disorders. As such, in the present embodiment, the advantageous comfort and breathability is provided without the provision of metal springs. In terms of the support provided by the foam material, it is preferred that the foam is not vacuum packed such that the visco foam material maintains a good appearance without any cell wall collapse.

In addition to providing comfort while sleeping, the mattress 10 includes four elongate boundary members 54 positioned underneath the upper layer 12 as shown. Each boundary member 54 is arranged to abut the lower surface 56 of the upper layer 12 and extend along the four sides 58 of the mattress 10. The elongate members 54 are advantageously provided as standard high hardness foam of about 200N. This hardness is greater than 1.4 times the hardness of the lower layer 16. The applicants have found boundary members made of Dunlop Endure EN38-200 foam advantageously maintain mattress strength and rigidity. The upper layer 12 provides a relatively soft touch at the edge around the boundary members 54.

The upper layer 12 is of a relatively larger planar size than the intermediate layer 14 and the lower layer 16. The boundary members 54 extend around the periphery 60 of the intermediate layer 14 and the lower layer 16. The upper layer 12 is disposed above the intermediate layer 14, the lower layer 16 and the boundary members 54.

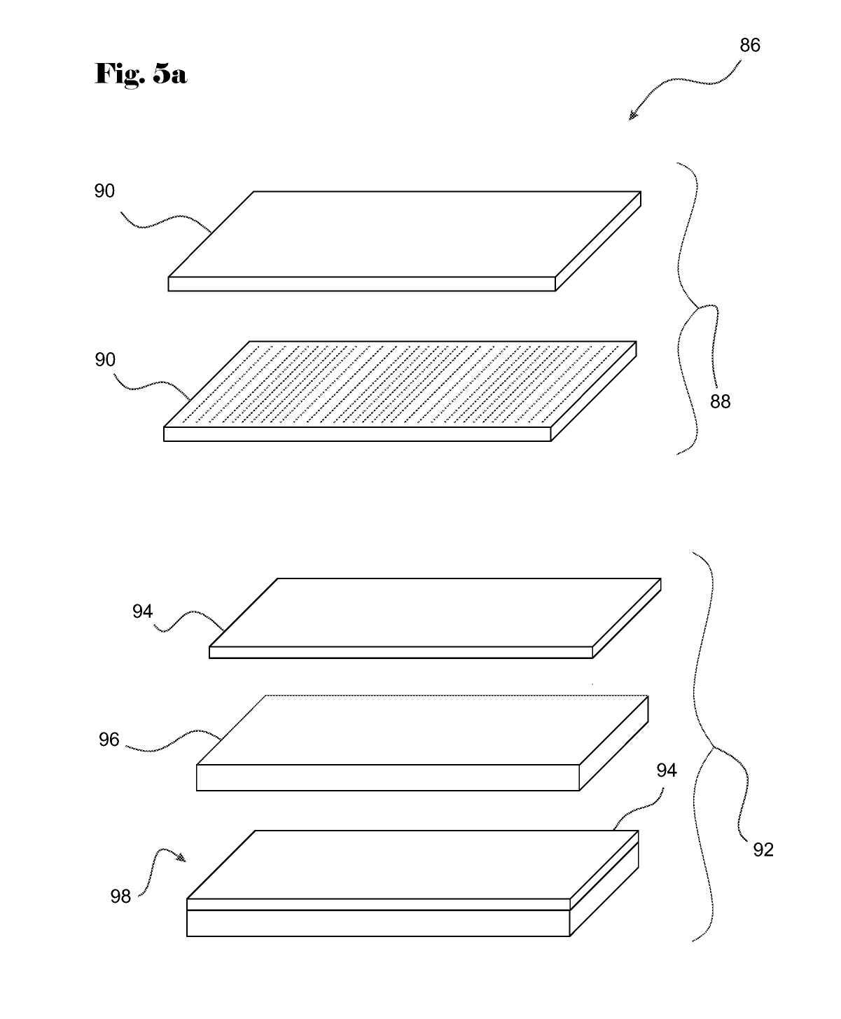

As shown in FIG. 4, the boundary area 62 adjacent the edge of the mattress 10 from above is advantageously provided with an increased degree of firmness due to support from the relatively firm boundary member 54 with the upper layer 12 being relatively soft to the touch.

As would be apparent from the drawings the passages 46 extend though the entire mattress 10 and also define the way the zoning is provided. The elongate members 54 provide a firm edge support arrangement where the members 54 are glued in position. The elongate members 64 are about 5 cm by 5 cm in cross-section.

In terms of the upper layer 12, the distance 64 to the ventilation passages is about 5 cm. In preferred embodiments the distance 64 is between 5 to 20 cm. The longitudinal edge spacing distance 66 is approximately 75 mm. The upper layer 12 covers the firm edge over the top to give an advantageously soft feel. The elongate members 54 (firm edges) are not perforated and neither is the portion of the upper layer 12 above the elongate members 54. In some embodiments the upper layer 12 is perforated above the elongate members 54.

The following three rows 68 of passages 46 are spaced at 70 mm. This provides a first inner zone depth 70 of about 280 mm less the distance 66. The following 6 rows are spaced at 50 mm. This provides a second inner zone depth 72 of about 300 mm. Following this the zoning arrangement includes: a third inner zone depth 74 of 280 mm; a fourth inner zone depth 78 of 300 mm; a fifth inner zone depth 80 of 280 mm; a sixth inner zone depth 82 of 300 mm; and a seventh inner zone depth 84 of 280 mm.

The zones alternate in a manner wherein relatively firm zones 26 are provided at each end of the mattress 10. The soft firm zones 30, are positioned between the relatively soft zones 26. As a result, at least some of the zones are of a width of least 300 mm in the direction along the mattress 10.

The mattress 10 is symmetrical through the mirror axis 36 midway along the length of the mattress 10. A longitudinal mirror axis 76 is also provided. The symmetrical nature of the mattress allows the mattress to be rotated with no real change in configuration.

In preferred embodiments the depth from the edge of the bed to the second zone is preferably between 95% to 100% of the second zone depth 72. The second zone depth 72, the fourth zone depth 78 and the sixth zone depth 82 are preferably equal in size. The third zone depth 74 and the fifth zone depth 78 are preferably between 95% to 100% of the second zone depth 72. The upper row 77 and the lower row 79 shown in FIG. 3 are not present in one embodiment.

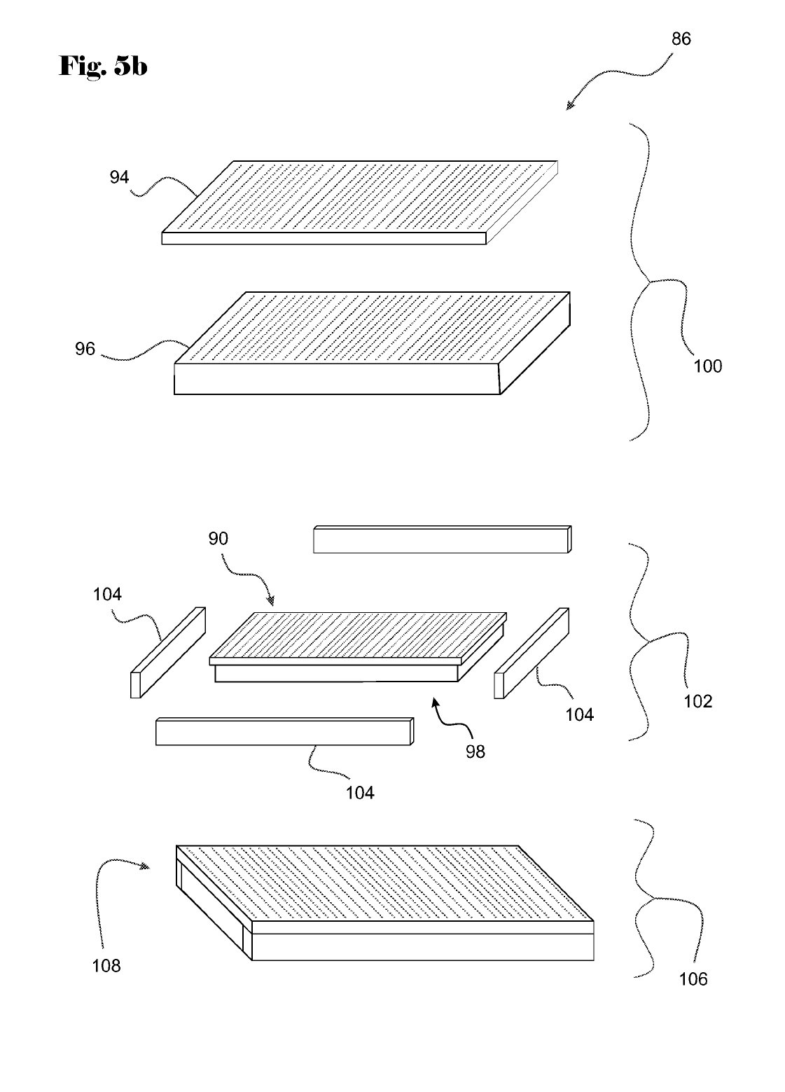

A method 86 according to a further preferred embodiment of the present invention is shown in FIGS. 5a and 5b. In the method 86 at block 88 an upper layer 90, of VF52-40 material is ventilated with an advantageous 7 zone sleeping pattern that is similar to the patterns previously described. This is achieved by proactively forming a number of vertically extending ventilation passages through the upper layer 90. This is despite the upper layer 90 including visco elastic material that has an open core structure allowing ventilation.

In the method 86 at block 92 an upper lower layer 94 and lowermost layer 96 are fixed together to form a lower core 98.

As detailed at block 100 the upper lower layer 94 and the lowermost layer 96 are ventilated with an advantageous 7-zone sleeping pattern prior to gluing. The upper lower layer 94 and the lowermost layer 96 are then advantageously glued together using non toxic adhesives. As part of the method 86 this includes aligning the apertures by inserting a number of alignment elements in the form of rods through apertures in both the upper lower layer 94 and lowermost layer 96 during the gluing process.

The upper layer 90 and the lower core 98 are then arranged and glued in a similar manner to provide continuous and aligned ventilation passages. The method 86 is accordingly used to provide a 3 layered mattress of substantial thickness. It is to be appreciated that the upper layer is 50 mm on both sides and at the top and foot more than the intermediate and lower layers. In embodiments, at least two layers need to be aligned prior to and for gluing after the holes have been punched.

The intermediate layer (upper lower layer) comprises VF60-90 foam of dimensions 1940×1730×50 mm. The lower layer (lowermost layer) comprises EN36-130 foam of dimensions 1940×1730×130 mm. The ventilation is provided with a hole punching system.

At block 102 a number of side rails 104 are provided for abutting against the lower surface of the upper layer 98 to provide continuous peripheral support. At block 106 the upper layer 90, the side rails 104 and the lower core 98 are glued to provide a complete mattress 108. This provides an advantageous three layer open cell foam mattress with seven zones of comfort as described.

Various sizes of mattress are presently preferred including the sizes detailed below.

| Size | Length | Width | |
|---|---|---|---|
| King | 2,030 mm | 1,830 | mm |
| Queen | 2,030 mm | 1,530 | mm |
| Double | 1,870 mm | 1,370 | mm |
| King Size Single | 2,030 mm | 1,060 | mm |
| Long Single | 2,030 mm | 920 | mm |
| Single | 1,870 mm | 920 | mm |

In this case the apertures are 5 mm in diameter. It is presently preferred that apertures are between 2 to 5 mm in diameter. In each horizontal row of cores (i.e. from side to side) the spacing between holes is 15 mm. It is presently preferred that the spacing ranges between say 10 to 30 mm.

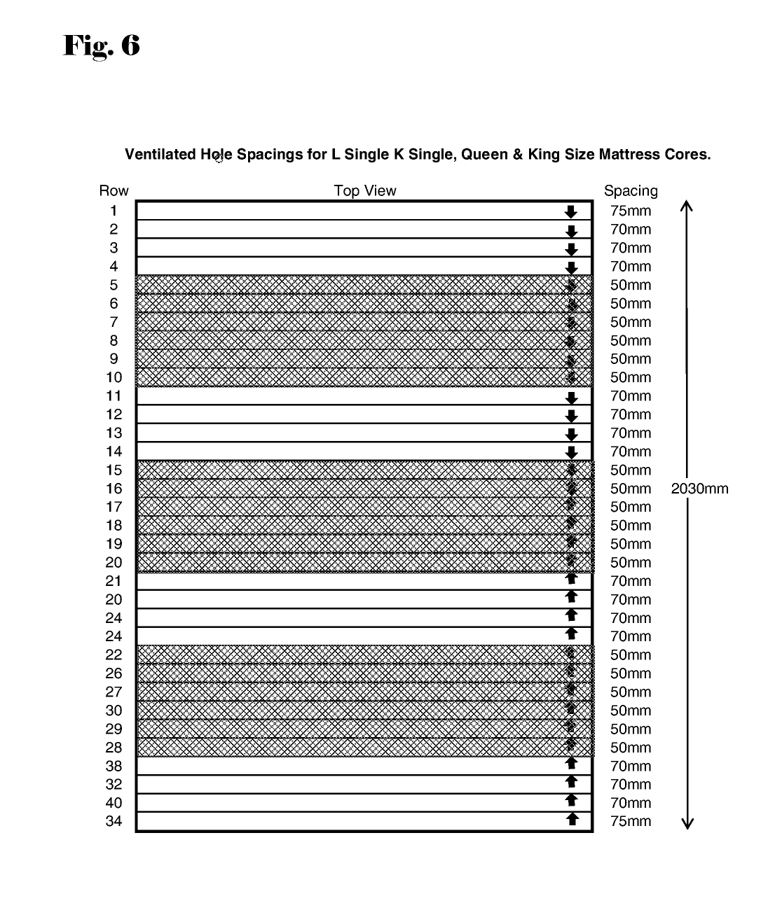

FIG. 6 illustrates a further preferred embodiment of the present invention. The ratio of spacing between relatively soft zones and relatively firm zones is about 7/5 (1.4). Ratios between 1.2 to 1.7 are presently preferred.

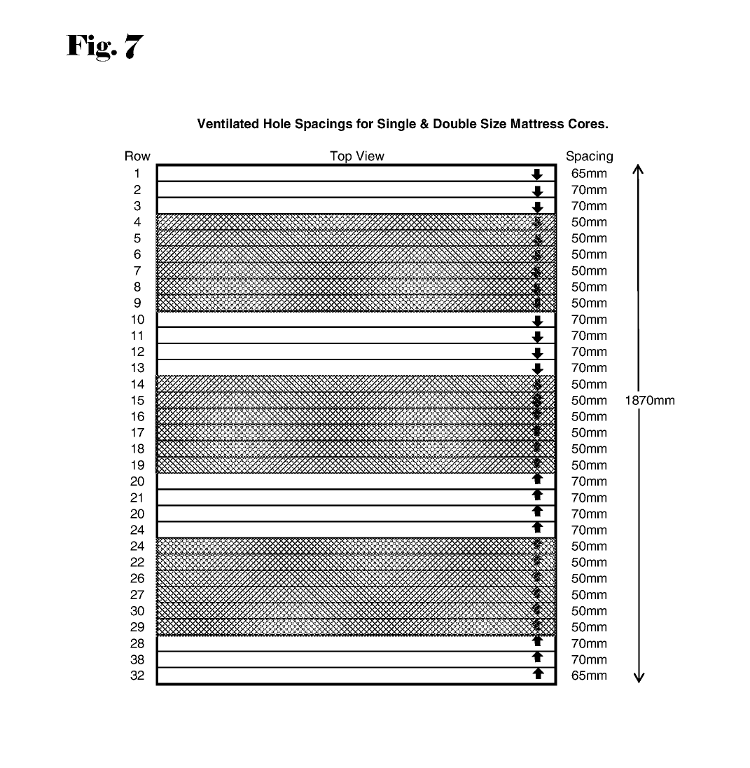

FIG. 6 illustrates an embodiment where the first zone depth is precisely 95% of the second zone depth. The first zone depth and the seventh zone depth are equal. The first zone depth and the seventh zone depth are only slightly larger than the third zone depth and the firth zone depth. The third zone depth and the firth zone depth are also equal). The bed is advantageously formed symmetrically about x and y axes. Each of the soft zones has three intermediate rows and each of the hard zones have five intermediate rows. A further preferred embodiment is shown in FIG. 7. Again the bed is dominated by a 1.4 relatively firm to soft row spacing (70/50 mm). In the embodiment the first zone depth and the seventh zone depth are reduced in size each having only two intermediate rows.

The embodiment described comprises rails on both the sides and top of the bed for further reinforcing the firmness of the peripheral zone. Thus in the embodiment the mattress advantageously comprises 3 separate layers of foam and rails on both sides and on the top and foot. In yet further designs rails are provided only on both sides or only on the top and foot of the beds. Yet further embodiments do not includes rails at all. Of course several variations are possible. Preferably the rails are not punched in order to advantageous provide a relatively rigid peripheral zone.

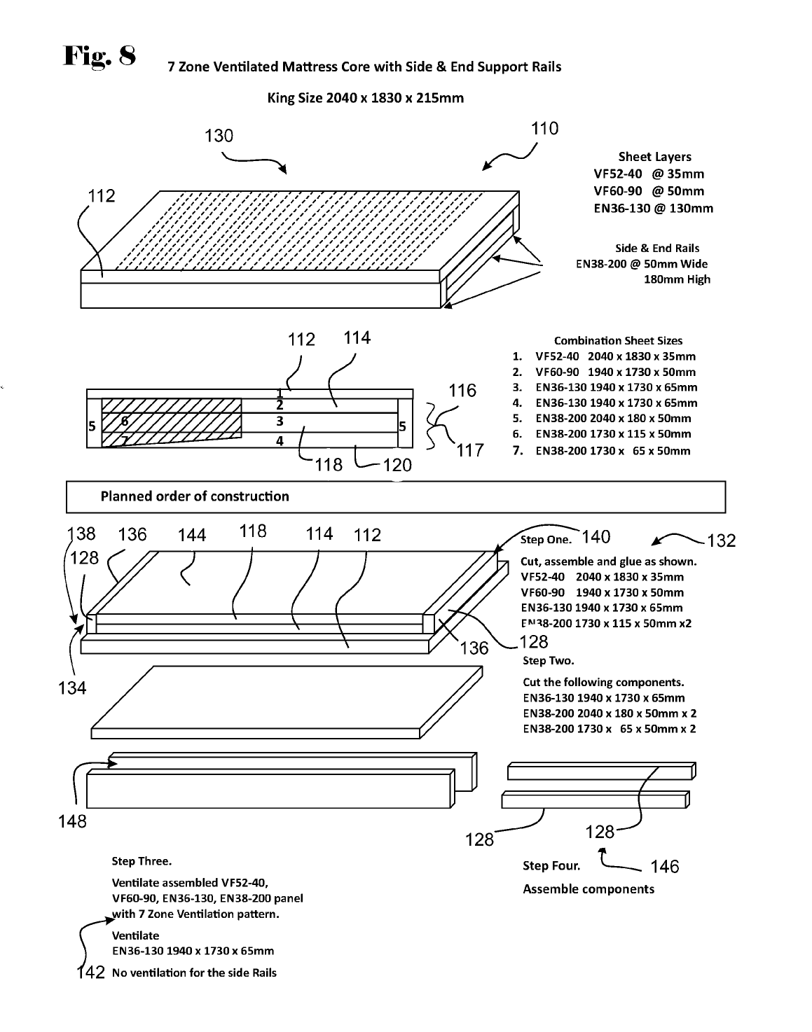

FIG. 8 illustrates a seven zoned mattress 110 according to a further embodiment of the present invention. The mattress 110 includes an upper layer 112 formed from visco elastic foam material of a first kind, an intermediate layer 114 formed from visco elastic foam material of a second kind and a lower layer 116 formed from visco elastic foam material of another kind.

The upper layer 112 and the intermediate layer 114 are formed from foam material to provide single unitary layers (without any sub-layers). The lower layer 116 is provided as a layered structure 117 comprising an upper-lower layer 118 and a lower-lower layer 120. In the embodiment shown in FIG. 8, the upper lower layer 118 and the lower-lower layer 120 are formed from visco elastic foam material of the same kind

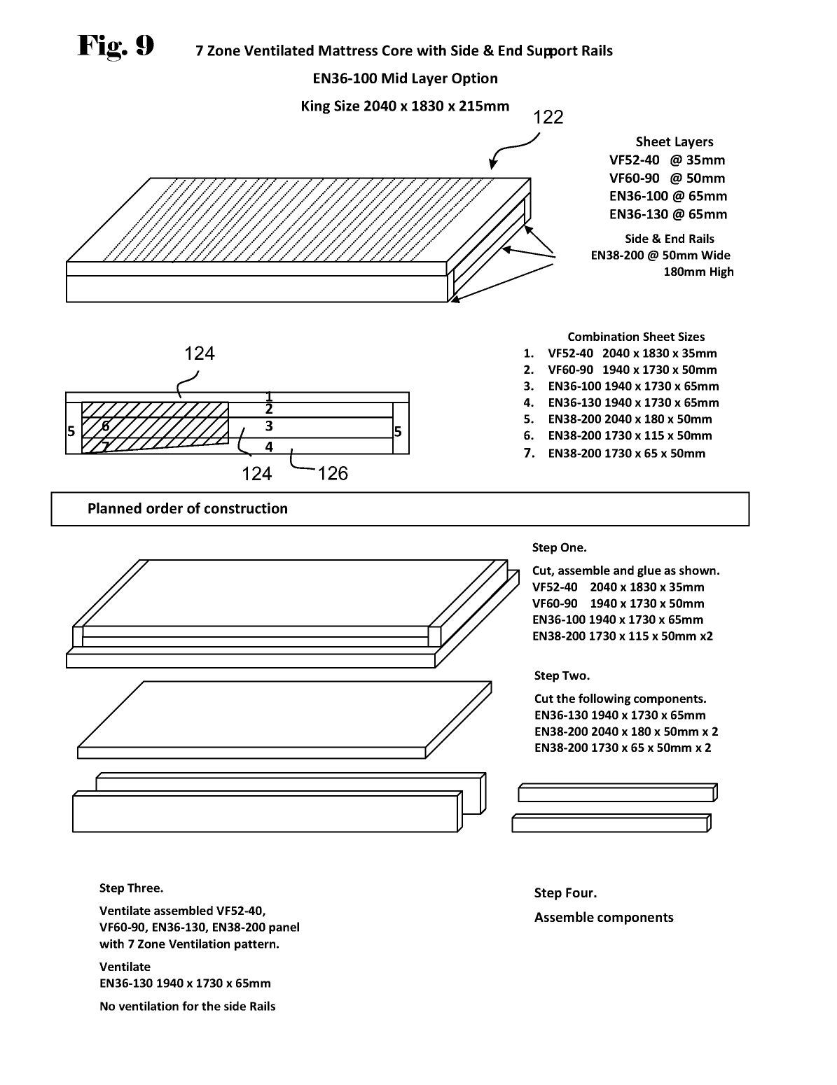

FIG. 9 illustrates a further embodiment in the form of a mattress 122. In the mattress 122 an upper-lower layer 124 and a lower-lower layer 126 are formed from foam material, each of a different kind. The upper-lower layer 124 is formed from EN-36-100 having a density of about 36 kg/m3 and a hardness of about 90-120 IFD 40%. The lower-lower layer 126 is formed from EN-36-30 having a density of about 36 kg/m3 and a hardness of about 120-150 IFD 40%.

The manufacture and form of the mattress 110 and the mattress 120 are similar, apart from the difference in the lower layer.

As shown in the embodiment of FIG. 8, the upper layer 112, the intermediate layer 114, the upper-lower layer 118 and the lower-lower layer 120 are provided as layers of visco elastic foam material. A number of end rails 128 are also provided. In the mattress 110 a number of ventilation passages 130 extend all the way through the mattress 110.

At block 132 the upper layer 112 is glued to the intermediate layer 114 and the upper lower layer 118 to form a layered structure 134. A first pair of end supportive portions 136 are also glued in the gluing step at a respective upper end 138 and a respective lower end 140 of the layered structure 134, underneath the upper layer 112.

At block 142, the layered structure 134 and the lower-lower layer 120 are separately ventilated. The holes are aligned using dowels that are positioned to extend through corresponding holes such that the ventilation passages 130 will extend through the full thickness of the mattress 110 in a relatively uninterrupted manner.

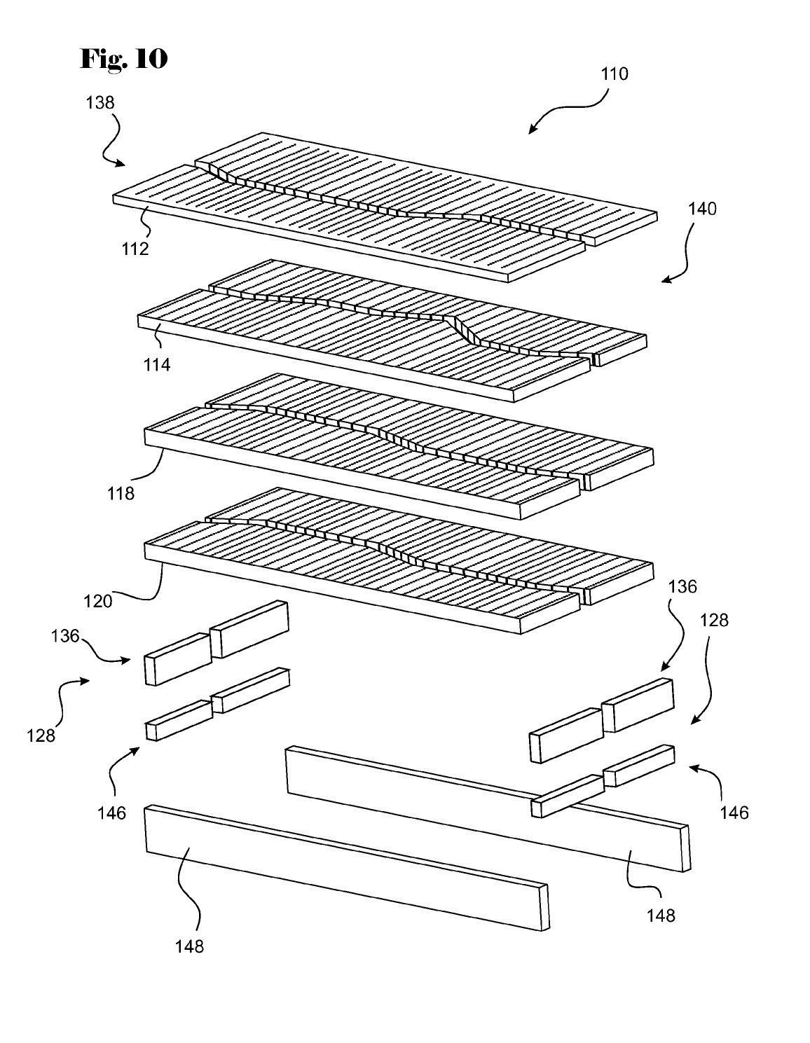

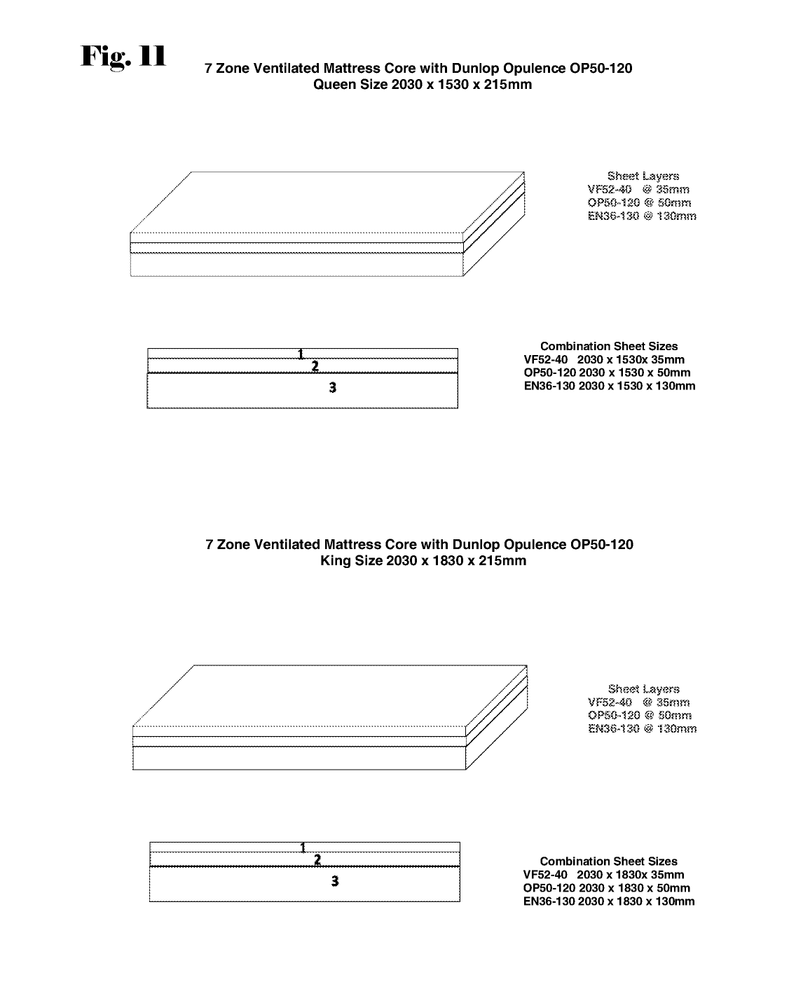

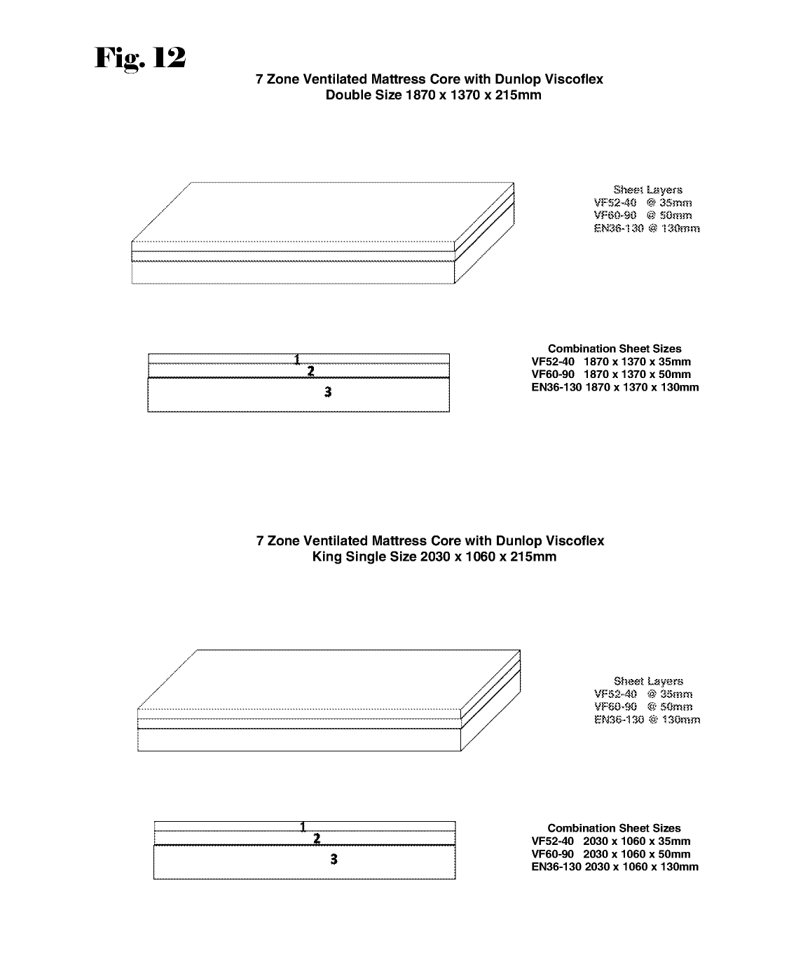

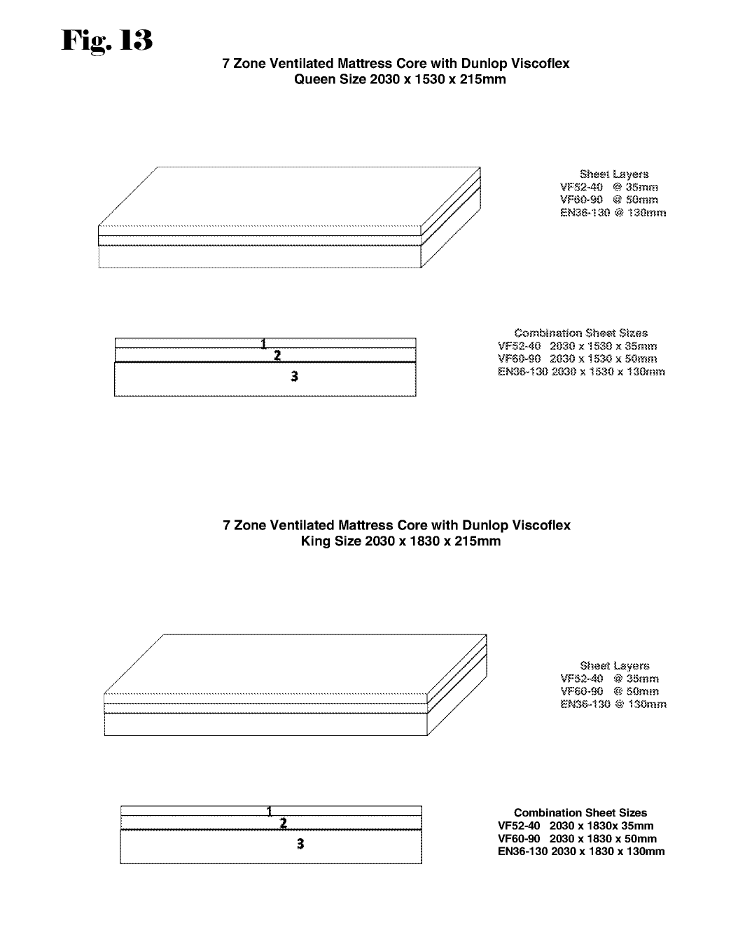

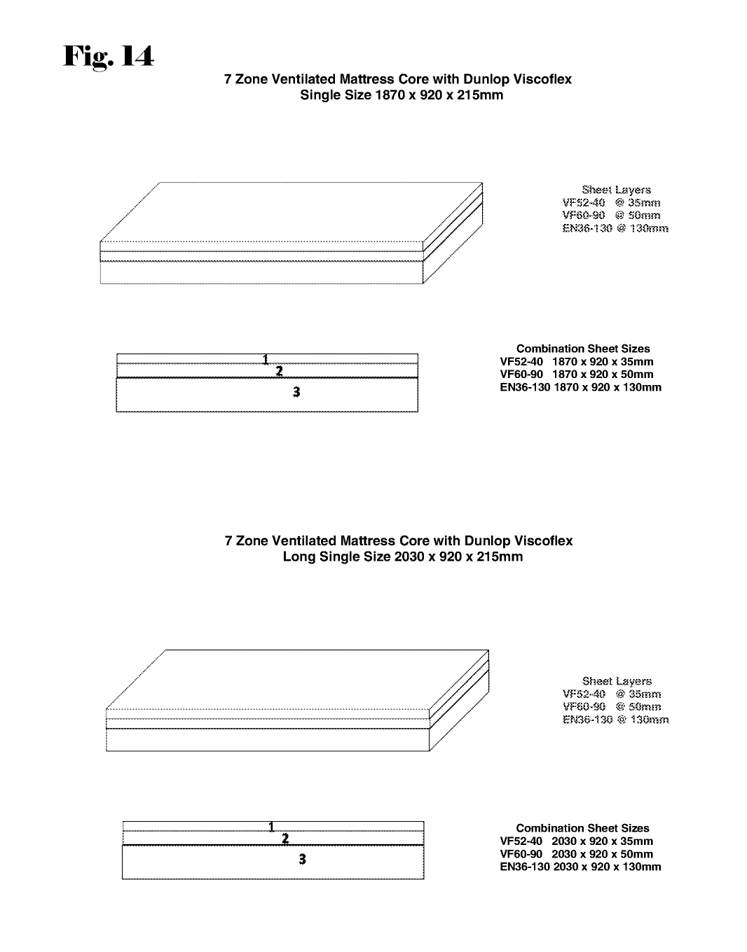

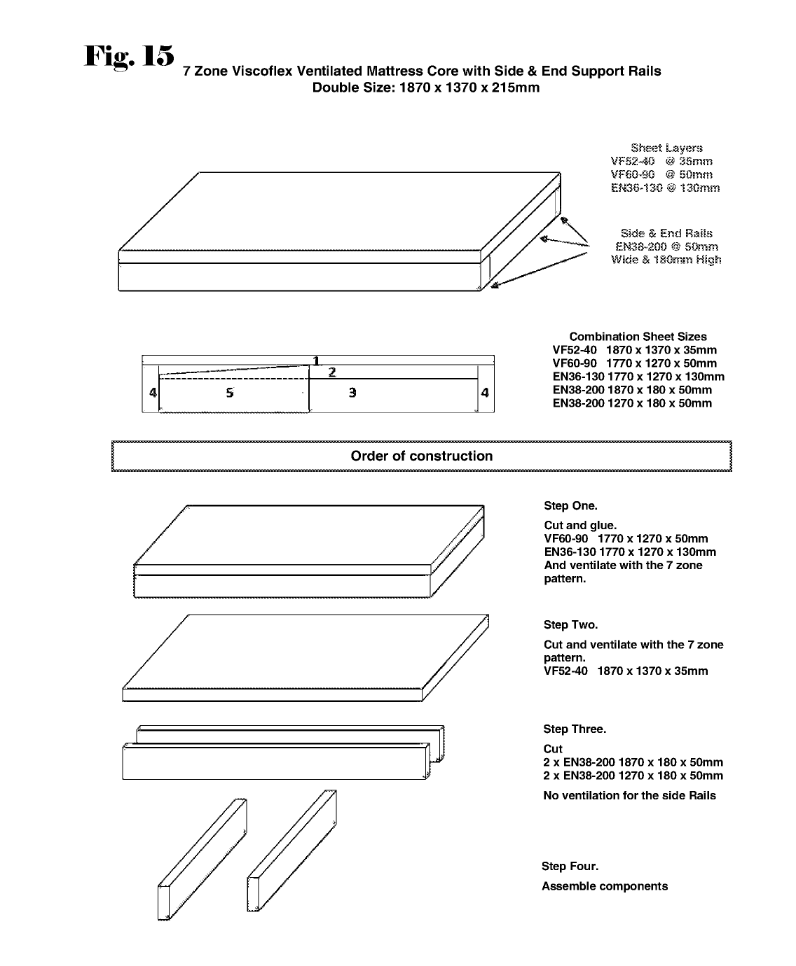

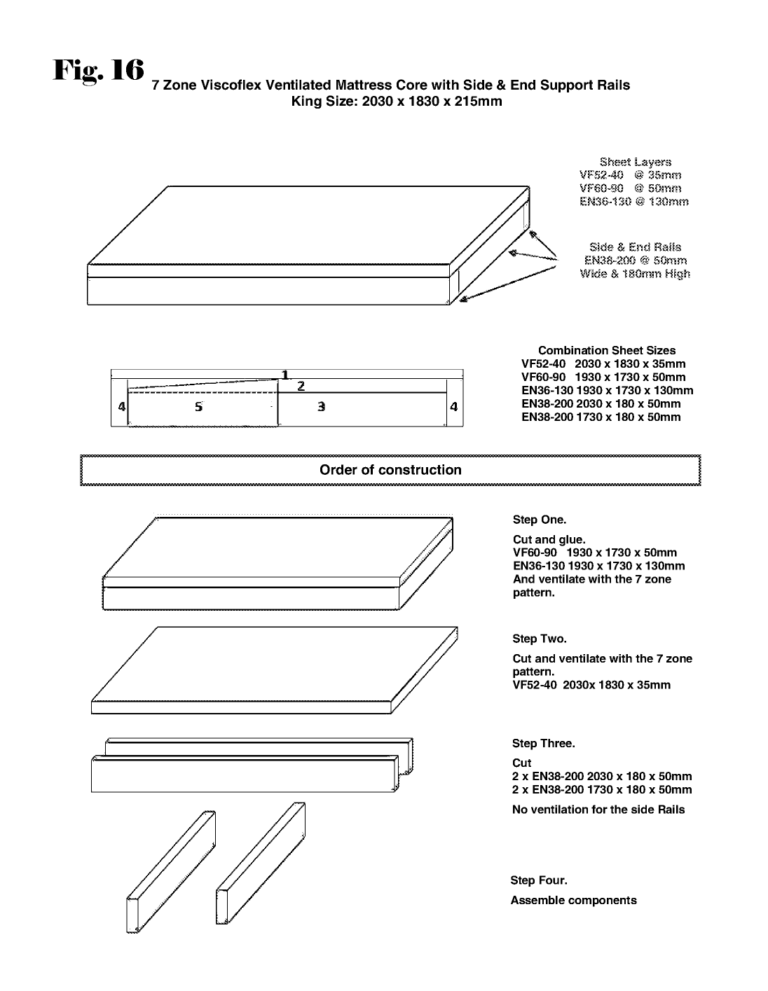

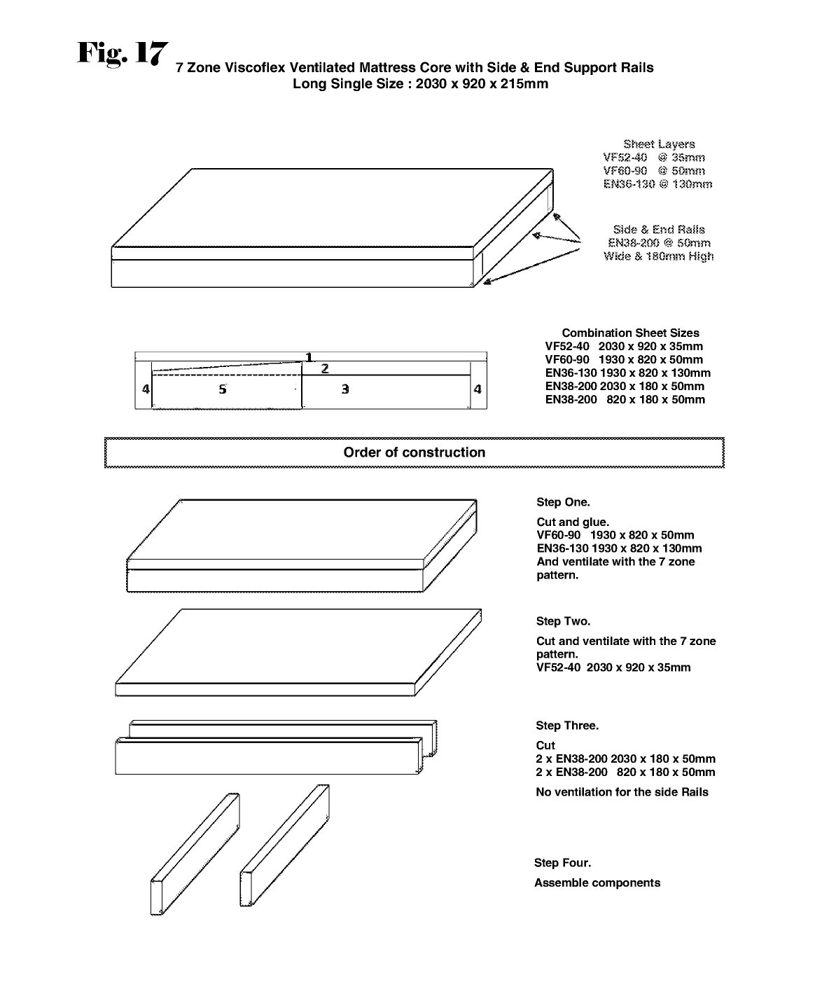

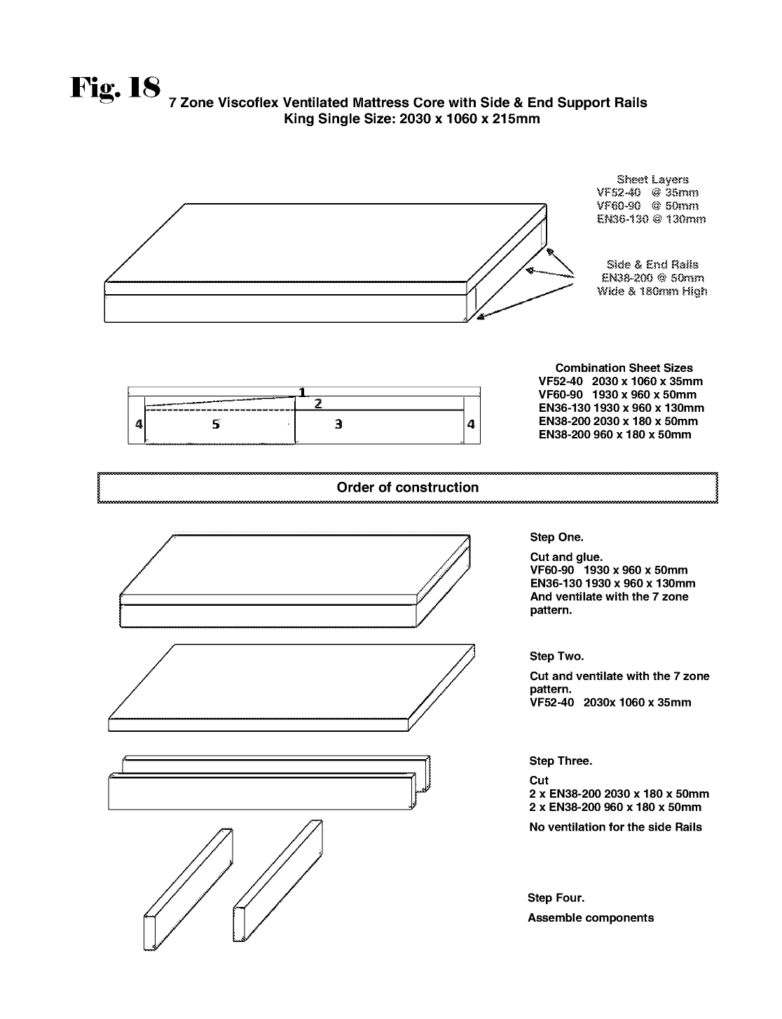

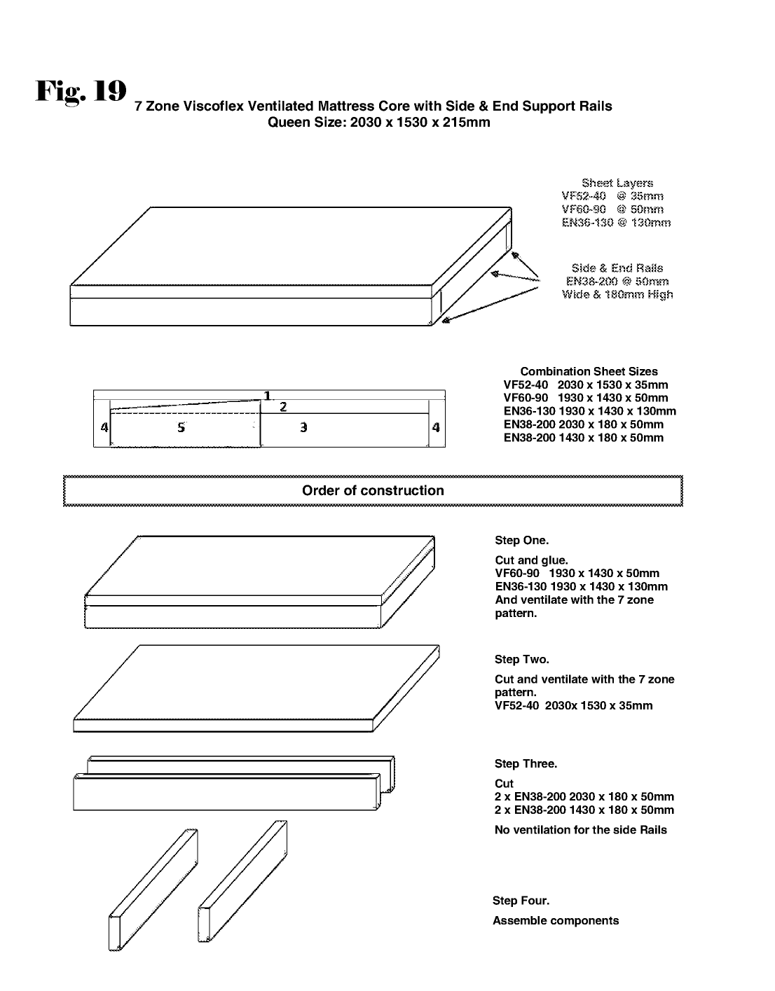

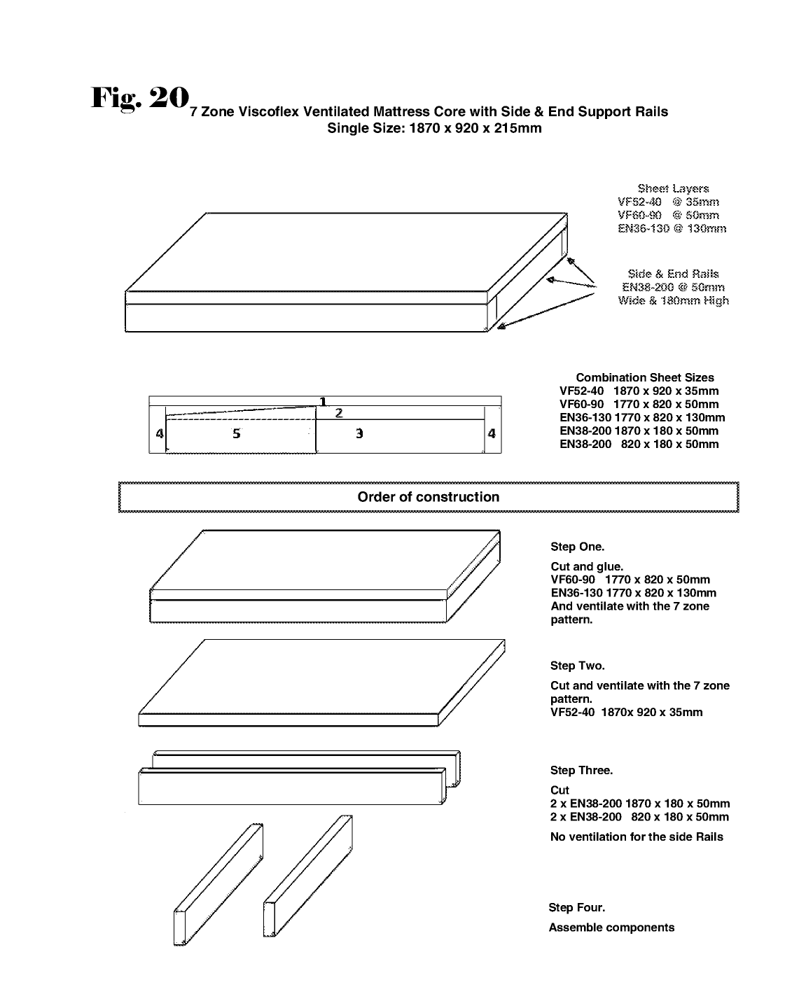

The outward surface 144 of the upper-lower layer 118 is then glued to a lower-lower layer 120 and a second pair 146 of end supportive portions and side rails 148 are glued in position to from the mattress 110. The side rails 148 and the end rails 128, 146 extend from beneath the upper layer 112. FIG. 10 illustrates the component parts of the mattress 110.

Several further preferred embodiments are illustrated in Figures to 11 to 18.

In a further preferred embodiment the mattress is provided with a washable certified organic cotton cover. This advantageously allows the end user to keep the mattress cover clean and healthy. Skin cells and dust mites can be removed and the mattress can be advantageously aired.

Thus it will be apparent that there has been described an advantageous mattress that is designed to promote beneficial posture when sleeping and which is considered to reduce localised pressure on the entire body.

Further advantages and preferred features will be apparent from a reading of the specification as a whole. Other advantageous features are shown in the drawings.

It is to be recognised that various alterations and equivalent forms may be provided without departing from the spirit and scope of the present invention. This includes modifications within the scope of the appended claims along with all modifications, alternative constructions and equivalents. There is no intention to limit the present invention to the specific embodiments shown in the drawings. The present invention is to be construed beneficially to the applicant and the invention given its full scope.

In the present specification, the presence of particular features does not preclude the existence of further features. The words ‘comprising’, ‘including’ and ‘having’ are to be construed in an inclusive rather than an exclusive sense.

1. A mattress for a bed, the mattress comprising:
an upper layer formed from visco elastic foam material of a first kind;
an intermediate layer formed from visco elastic foam material of a second kind;
a lower layer formed from foam material of another kind;
wherein the intermediate layer is provided between the upper layer and the lower layer; the upper layer and the intermediate layer have a combined thickness of at least 50 mm; and the lower layer has a thickness of at least 70 mm.

2. A mattress as claimed in claim 1 wherein the upper layer, intermediate layer and the lower layer each consist of a single unitary layer.

3. A mattress as claimed in claim 2 wherein the lower layer consists of two layers, namely an upper-lower layer and a lower-lower layer.

4. A mattress as claimed in claim 1 wherein the layers are glued together with the upper layer being at least 25 mm in thickness, the intermediate layer being at least 30 mm in thickness and the lower layer being at least 100 mm in thickness.

5. A mattress as claimed in claim 1 wherein the upper layer is formed from visco elastic foam of a hardness between 30 and 60 N; the intermediate layer is formed from visco elastic foam of a hardness between 70 and 110 N; and the lower layer is formed from foam of a hardness between 85 and 130 N.

6. A mattress as claimed in claim 1 including a plurality of boundary members extending along the lateral sides of the mattress to provide the mattress with relatively firm side support portions.

7. A mattress as claimed in claim 1 including a plurality of boundary members extending along the ends of the mattress to provide the mattress with relatively firm end support portions.

8. A mattress as claimed in claim 7 wherein the upper layer is of a larger planar size than the intermediate layer and the lower layer, the boundary members surround the periphery of the intermediate layer and the lower layer, and the upper layer is disposed above the intermediate layer, the lower layer and the boundary members.

9. A mattress as claimed in claim 1 wherein the density of the upper layer of visco elastic foam material is between 47 and 57 kg/m3; the density of the intermediate layer of visco elastic foam material is between 55 and 6.5 kg/m3; and the density of the lower layer of foam material is between 31 and 41 kg/m3.

10. A mattress as claimed in claim 1 wherein the hardness of the upper layer of visco elastic foam material is between 30 and 60 (IFD 40%); the hardness of the intermediate layer of visco elastic foam material is between 75 and 105 (IFD 40%); and the hardness of the lower layer of foam material is between 115 and 155 (IFD 40%).

11. A mattress as claimed in claim 1 wherein the lower layer consists of two layers, namely an upper-lower layer and a lower-lower layer; the hardness of the upper-lower layer being less than the hardness of the lower-lower layer.

12. (canceled)

13. (canceled)

14. A mattress as claimed in claim 38 wherein and at least some of the zones are of a depth of least 250 mm in the longitudinal direction along the mattress.

15. A mattress as claimed in claim 14 wherein the ventilation passages provide the sleeping zones with relatively soft and relatively firm sleeping zones that alternate along the length of the mattress.

16. A mattress as claimed in claim 1 including a number of ventilation passages extending all the way through the mattress, from the upper surface of the upper layer through the lower surface of the lower layer; the ventilation passages providing the mattress with a number of supportive zones; wherein the relatively firm sleeping zones each include only two or three internal rows of vertically extending passages.

17. A mattress as claimed in claim 1 including a number of ventilation passages extending all the way through the mattress, from the upper surface of the upper layer through the lower surface of the lower layer; the ventilation passages providing the mattress with a number of supportive zones; wherein the relatively soft sleeping zones each include less than 10 internal rows of vertically extending passages.

18. A mattress as claimed in claim 1 including a number of ventilation passages extending all the way through the mattress, from the upper surface of the upper layer through the lower surface of the lower layer; the ventilation passages providing the mattress with a number of supportive zones; wherein the relatively soft sleeping zones each include less than 6 internal rows of vertically extending passages.

19. (canceled)

20. (canceled)

21. (canceled)

22. (canceled)

23. (canceled)

24. (canceled)

25. (canceled)

26. (canceled)

27. (canceled)

28. (canceled)

29. A method of manufacturing a mattress comprising:
providing number of layers of visco elastic foam material; forming a number of ventilation passages in one or more of the layers visco elastic foam material, despite the visco elastic foam material having an open core structure allowing natural ventilation; and forming a mattress using the layers of visco elastic foam material; the ventilation passages extending all the way through the mattress; and the mattress comprising: an upper layer formed from visco elastic foam material of a first kind; an intermediate layer formed from visco elastic foam material of a second kind; a lower layer formed from foam material of another kind; with the intermediate layer being provided between the upper layer and the lower layer; the upper layer and the intermediate layer having a combined thickness of at least 50 mm; and the lower layer having a thickness of at least 70 mm.

30. (canceled)

31. (canceled)

32. (canceled)

33. (canceled)

34. (canceled)

35. (canceled)

36. (canceled)

37. A mattress for a bed as claimed in claim 1 including a number of ventilation passages extending all the way through the mattress, from the upper surface of the upper layer through the lower surface of the lower layer.

38. A mattress for a bed as claimed in claim 37 wherein the ventilation passages provide the mattress with as number of supportive zones.

39. A method as claimed in claim 29 wherein forming the ventilation passages comprises forming the passages in the upper layer and the intermediate layer, the upper layer being of a first hardness and the intermediate layer being of a second hardness.

40. A method as claimed in claim 29 including gluing the upper layer, intermediate layer and lower layer together and gluing a first pair of end support portions to the upper layer, intermediate layer and lower layer at a respective upper end and a respective lower end of the layers.

41. A method as claimed in claim 40 wherein the ventilation passages extend through the layers and the support portions do not include any ventilation passages.

42. A method as claimed in claim 41 wherein the outward surface of third layer in the layered structure is glued to a fourth layer of visco elastic material and a second pair of end support portions are glued to the first pair of end support portions to provide end supports extending from beneath the first layer.

43. A method as claimed in claim 29 wherein the upper layer of visco elastic foam material is larger than the second and third layers such that boundary members can be positioned around the periphery of the second and third foam layers to support the periphery of the first layer of foam material from below.
